(19) United States
(12) Patent Application Publication
(10) Pub. No.: US 2017/0226739 A1
(43) Pub. Date: Aug. 10, 2017

(54) CURVED SCREEN FRAME AND THEATER COMPRISING SAME

(71) Applicant: CJ CGV CO., LTD., Seoul (KR)

(72) Inventors: Bon Il KOO, Seoul (KR); Byoung Jun SONG, Incheon (KR); Hae Jeong KOH, Seoul (KR); Min Jung KIM, Seoul (KR); Young Mi KIM, Seoul (KR); Ok Sun KIM, Seoul (KR); No Chan PARK, Incheon (KR); In Jae SEONG, Seoul (KR); Young Wook CHOI, Seoul (KR)

(21) Appl. No.: 15/326,447

(22) PCT Filed: Jul. 15, 2015
(86) PCT No.: PCT/KR2015/007371

§ 371 Date: Jan. 13, 2017

(30) Foreign Application Priority Data
Jul. 15, 2014 (KR) 10-2014-0089365
Jul. 15, 2015 (KR) 10-2015-0100576

(51) Int. Cl. E04C 3/38; G03B 21/56

(52) U.S. Cl. CPC E04C 3/38; G03B 21/56

(57) ABSTRACT

The present invention relates to a method of providing image data based on cloud streaming. In particular, the method uses memory space of a terminal, prestores image data in the terminal, captures an execution screen regarding execution of a specific application, extracts video content from the prestored image data based on the captured execution screen and information regarding the execution screen, simultaneously encodes individual items of the extracted video content, and provides the encoded video content to a screen. Thus, according to the present invention, usage of the cloud streaming server and the network may be reduced by an amount commensurate with the resources utilization of the terminal. Network load may also be reduced when a live video or a VOD video is not being watched, and the rich GUI experience may be guaranteed in a standby state.

### TECHNICAL FIELD

The present invention relates to a screen frame having curvature and to a screen frame including a pair of long-axis members formed in a first direction and spaced apart from each other at a specific interval and a pair of short-axis members formed in a second direction and spaced apart from each other at a specific interval, wherein the long-axis members and the short-axis members have curvature of a specific size and the pair of long-axis members and the pair of short-axis members are joined together to have four corners.

### BACKGROUND ART

In general, a movie theater has a structure in which a rectangle screen is provided in a building of a rectangular parallelepiped having the vertical surface of a wall, and is fabricated to allow audiences to watch visual media within a specific space.

However, such a rectangle screen has structural problems in that a three-dimensional effect is not present and a sense of immersion is not sufficient because visual media is projected on a plane screen when audiences watch the visual media. Accordingly, various methods are recently suggested in order to solve such problems.

The present invention has been invented based on such a technological background and also has been invented to satisfy the aforementioned technological needs and to provide additional technological elements that may not be easily invented by those skilled in the art to which the present invention pertains.

### DISCLOSURE

### Technical Problem

The present invention has been made keeping in mind the above problems occurring in the prior art, and an object of the present invention is to form horizontal and horizontal curvature in a screen using members having curvature in a vertical axis in addition to a horizontal axis.

Furthermore, an object of the present invention is to enable an audience to have a sense of immersion and to transfer a high feeling of movement by holding a screen having curvature so that it has an optimum curvature ratio. Furthermore, an object of the present invention is to allow an audience to have various effects by controlling the height and angle of a screen having curvature along with the angle of an audience seat according to the running time of a movie.

Furthermore, an object of the present invention is to enhance a sense of immersion by providing a tilt to a screen so that the top of the screen becomes close to the visual field of an audience.

Furthermore, an object of the present invention is to implement a three-dimensional effect within a screen because the screen has right and left and top and bottom curvature and thus to enable an audience to have a 3-D effect when watching a 2-D movie and to have a three-dimensional effect as if the audience watches a picture of an actual event when watching a 3-D movie.

### Technical Solution

To achieve the above object, a screen frame having curvature according to the present invention may include a pair of long-axis members formed in a first direction and spaced apart from each other at a specific interval and a pair of short-axis members formed in a second direction and spaced apart from each other at a specific interval. The long-axis member and the short-axis member may have curvature of a specific size, and the pair of long-axis members and the pair of short-axis members may be joined together to have four corners.

Furthermore, the pair of long-axis members may include a first long-axis member and a second long-axis member, the pair of short-axis member may include a first short-axis member and a second short-axis member, the first long-axis member may have one end joined to one end of the first short-axis member and have the other end joined to one end of the second short-axis member, and the second long-axis member may have one end joined to the other end of the first short-axis member and have the other end joined to the other end of the second short-axis member.

In addition, a ratio of the curvature radii of the first long-axis member, the second long-axis member and the short-axis member may be 1:1:0.6˜1.0 or an angle formed by a straight line connecting the first long-axis member and the second long-axis member at the shortest distance and the vertical pole of a support may be 10 to 20 degrees.

Furthermore, the screen frame may further include a diagonal member having one end and the other end respectively joined to points of the long-axis member and the short-axis member joined together.

Furthermore, the long-axis member and the short-axis member may have different points having two or more pieces of curvature within a single member.

Meanwhile, the present invention may further include post units formed in one direction with curvature of a specific size and spaced apart from the long-axis member or the short-axis member at a specific interval and beams joined between the post units and the long-axis member or the post units and the short-axis member.

Another screen frame having curvature according to the present invention may include a first long-axis member and a second long-axis member formed in a first direction and spaced apart from each other at a specific interval and a first short-axis member and a second short-axis member formed in a second direction and spaced apart from each other at a specific interval. An angle formed by a straight line connecting the first long-axis member and the second long-axis member at the shortest distance and the vertical pole of a support may be 10 to 20 degrees.

In this case, the short-axis member may support the vertical axis of a screen and have curvature of a specific size. A ratio of the curvature radii of the first long-axis member, the second long-axis member and the short-axis member may be 1:1:0.6˜1.0. The screen frame may further include a diagonal member having one end and the other end respectively joined to points of the long-axis member and the short-axis member joined together.

Furthermore, the first and the second long-axis members and the first and the second short-axis members may have different points having two or more pieces of curvature within a single member.

Furthermore, the present invention may further include post units formed in one direction with curvature of a specific size and spaced apart from the first and the second long-axis members or the first and the second short-axis members at a specific interval and beams joined between the post units and the first long-axis member or the post units and the first short-axis member or the post units and the second long-axis member or the post units and the second short-axis member.

A theater equipped with a screen frame having curvature according to the present invention may include a pair of long-axis members formed in a first direction and spaced apart from each other at a specific interval and a pair of short-axis members formed in a second direction and spaced apart from each other at a specific interval. The long-axis member and the short-axis member may have curvature of a specific size, and the pair of long-axis members and the pair of short-axis members may be joined together to have four corners.

Furthermore, the pair of long-axis members may include a first long-axis member and a second long-axis member, the pair of short-axis member may include a first short-axis member and a second short-axis member, the first long-axis member may have one end joined to one end of the first short-axis member and have the other end joined to one end of the second short-axis member, and the second long-axis member may have one end joined to the other end of the first short-axis member and have the other end joined to the other end of the second short-axis member.

In addition, a ratio of the curvature radii of the first long-axis member, the second long-axis member and the short-axis member may be 1:1:0.6˜1.0 or an angle formed by a straight line connecting the first long-axis member and the second long-axis member at the shortest distance and the vertical pole of a support may be 10 to 20 degrees. The long-axis member and the short-axis member may have different points having two or more pieces of curvature within a single member.

A method for fabricating a screen frame having curvature according to the present invention may include the steps of (a) fabricating a pair of long-axis members formed in a first direction with curvature of a specific size and a pair of short-axis members formed in a second direction with curvature of a specific size, (b) placing the pair of short-axis members in such a way as to be spaced apart from each other at a specific interval, and (c) joining the pair of short-axis members and the pair of long-axis members to form four corners.

Furthermore, the pair of long-axis members may include a first long-axis member and a second long-axis member, and the pair of short-axis members may include a first short-axis members and a second short-axis member. At the step (c), the first long-axis member may have one end joined to one end of the first short-axis member and have the other end joined to one end of the second short-axis member, and the second long-axis member may have one end joined to the other end of the first short-axis member and have the other end joined to the other end of the second short-axis member.

Furthermore, at the step (a), the first long-axis member, the second long-axis member and the short-axis member may be fabricated to have a ratio of curvature radii of 1:1:0.6˜1.0. At the step (a), the long-axis member and the short-axis member may be fabricated to have different points having two or more pieces of curvature within a single member. The step (a) may include i) placing post units formed in one direction with curvature of a specific size in such a way as to be spaced apart from the long-axis member or the short-axis member at a specific interval and ii) joining beams between the post units and the long-axis member or the post unit and the short-axis member.

In a method for installing a screen frame having curvature according to the present invention, the screen frame includes a first long-axis member and a second long-axis member formed in a first direction with curvature of a specific size and a first short-axis member and a second short-axis member formed in a second direction with curvature of a specific size. The method may include the steps of (a) disposing a plurality of vertical poles in a vertical direction to a ground, (b) joining a plurality of horizontal poles to the vertical poles in a horizontal direction to the ground, and (c) installing the horizontal poles so that the first and the second long-axis members and the first and the second short-axis members have four corners.

In this case, at the step (a), the vertical poles may be closely attached to a surface of a wall of a theater. At the step (c), the first long-axis member, the second long-axis member, the first short-axis member and the second short-axis member may be installed on the horizontal poles to form a ratio of curvature radii of 1:1:0.6˜1.0. At the step (c), an angle formed by a straight line connecting the first long-axis member and the second long-axis member at the shortest distance and the vertical poles may be 10 to 20 degrees.

### Advantageous Effects

In accordance with the present invention, a screen having curvature can be stably installed easily even without a separate change of the design in a building of a rectangular parallelepiped or a structure for viewing because a screen having curvature of a specific value is held in a vertical axis in addition to a horizontal axis.

Furthermore, the present invention enables an audience to have a sense of immersion and transfer a high feeling of movement to an audience because a screen having curvature is held so that it has an optimum curvature ratio.

Furthermore, the present invention allows an audience to have various effects by controlling the height and angle of a screen having curvature along with the angle of an audience seat according to the running time of a movie.

Furthermore, the present invention enhances a sense of immersion by providing a tilt to a screen so that the top of the screen becomes close to the visual field of an audience. Furthermore, the present invention can implement a three-dimensional effect within a screen because the screen has right and left and top and bottom curvature and thus enables an audience to have a 3-D effect when watching a 2-D movie and to have a three-dimensional effect as if the audience watches a picture of an actual event when watching a 3-D movie.

### DESCRIPTION OF DRAWINGS

FIG. 1 is a diagram showing the structure of a screen frame having curvature according to an embodiment of the present invention.

FIG. 2 is a diagram showing a shape of a screen according to the screen frame having curvature according to an embodiment of the present invention.

FIG. 3 is a diagram showing a shape of a screen according to the screen frame having curvature according to another embodiment of the present invention.

FIG. 4 is a side view seen from the side if the screen frame having curvature according to an embodiment of the present invention has curvature of the ratio of 1:1:0.6˜1.0 and a tilt of 10 to 20 degrees.

FIG. 5 is a reference diagram for illustrating the tilt of the screen frame having curvature according to an embodiment of the present invention.

FIG. 6 is a diagram showing the structure of the screen frame having curvature to which diagonal members have joined in accordance with an embodiment of the present invention.

FIG. 7 is a diagram showing the structure of a short-axis member of the elements of the screen frame having curvature according to an embodiment of the present invention.

FIG. 8 is a diagram showing a structure for coupling the screen frame having curvature according to an embodiment of the present invention to a screen support having curvature.

FIG. 9 is a reference diagram for illustrating an experiment in which a screen is divided into 16 equal parts and the distance in each area is measured in order to check an optimum tilt of the screen frame having curvature according to an embodiment of the present invention.

FIG. 10 is a reference diagram for illustrating an experiment in which an area that belongs to the 16 equal parts of the screen and has sagged is divided into 16 equal parts again and an accurate sagged area is measured in order to check an optimum tilt of the screen frame having curvature according to an embodiment of the present invention.

### MODE FOR INVENTION

The details of the objects and technological configurations of the present invention and acting effects thereof will be more clearly understood from the following detailed description based on the accompanying drawings. Hereinafter, embodiments of the present invention are described in detail with reference to the accompanying drawings.

Embodiments disclosed in this specification should not be interpreted as limiting or used to limit the range of right of the present invention. It is evident to those skilled in the art that a description including the embodiments of this specification has various applications. Accordingly, unless otherwise defined by the claims, some embodiments described are illustrative for better understanding, and the range of right of the present invention is not intended to be restricted by the embodiments.

Function blocks illustrated in the drawings and described hereunder are only examples of possible implementations. In other implementations, different functional blocks may be used without departing from the spirit and scope of the detailed description. Furthermore, one or more functional blocks of the present invention are illustrated as separate blocks, but one or more of the functional blocks of the present invention may be a combination of various hardware and software elements for executing the same function.

Furthermore, it should be understood that an expression that some elements are included is an expression of an open type and the expression simply denotes that the corresponding elements are present, but does not exclude additional elements.

Furthermore, when it is said that one element is connected or coupled to the other element, it should be understood that one element may be directly connected or coupled to the other element, but a third element may exist between the two elements. Furthermore, expressions, such as “the first” and “the second”, are expressions used to only distinguish a plurality of elements from one another, and do not limit the sequence of the elements or other characteristics.

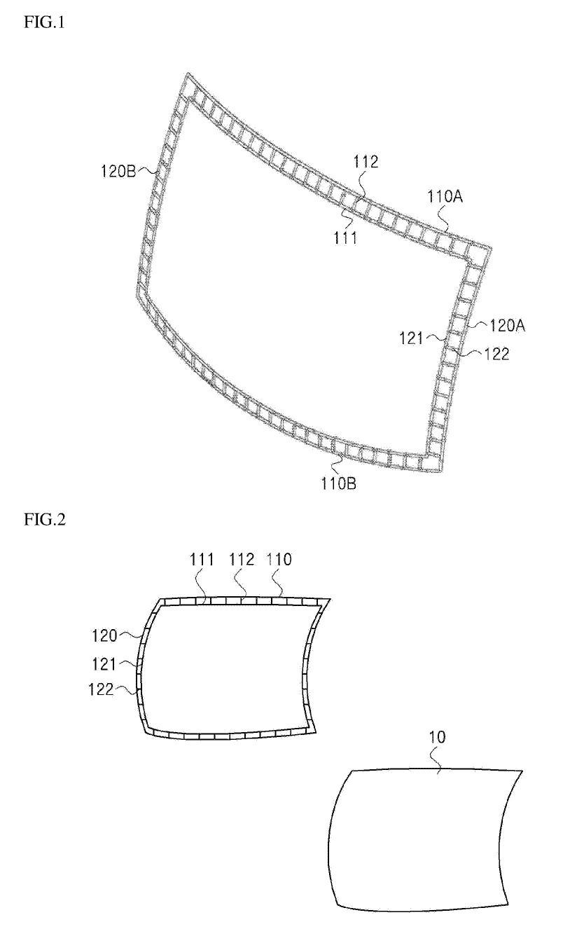

FIGS. 1, 2 and 3 are diagrams showing the structure of a screen frame 100 having curvature according to an embodiment of the present invention.

Referring to FIGS. 1, 2 and 3, the screen frame 100 having curvature according to an embodiment of the present invention includes a plurality of short-axis members 120 and a plurality of long-axis members 110. More specifically, the screen frame may include a pair of the long-axis members 110 formed in a first direction and spaced apart from each other at a specific interval and a pair of short-axis members 120 formed in a second direction and spaced apart from each other at a specific interval. The long-axis member 110 and the short-axis member 120 may have curvature of a specific size, and the pair of long-axis members 110 and the pair of short-axis members 120 may be joined together to have four corners.

In this case, the frame refers to a structure joined to a support in order to maintain the shape of a screen 10 having curvature. The frame includes the long-axis members 110 or the short-axis member having curvature and functions to closely attach the screen to the members, thereby eventually implementing the screen 10 having curvature. In this case, the long-axis member 110 is longer than the short-axis member 120. In view of the characteristics of the screen installed on a theater, the long-axis members 110 are disposed in a horizontal axis, and the short-axis members 120 are disposed in a vertical axis.

Furthermore, the screen 10 having curvature collectively refers to projection surfaces mace of various materials and joined to the frame for forming a shape of the screen. The screen 10 refers to a screen having curvature of a specific size in the horizontal axis or vertical axis depending on curvature of the long-axis members 110 or short-axis members 120 that form the frame. In this case, the screen is fabricated to be greater than the frame because perforations are generally formed in the screen uniformly. A shape of the screen 10 having curvature screen is preferably formed in such a way as to bind the long-axis members 110 and short-axis members 120 of the frame or post units 111 and 121 or beams 112 and 122 spaced apart from the members at specific intervals and the screen using a string.

Meanwhile, “joining” used in the present invention means that independent members maintain contact with each other, and comprehensively includes meanings, such as binding, attachment, adhesion, coupling, welding and holding. It is evident that the joining of the screen and the frame is not limited to a method for binding the screen and the frame using a string. Accordingly, various methods, such as a method for additionally attaching a magnetic member to the screen 10 and frame having curvature, a method for attaching intake means to the frame so that the screen 10 having curvature is closely attached to the frame and a method for coating an adhesive substance on the frame so that the screen 10 having curvature is closely attached to the frame, may be taken into consideration as the method for joining.

Furthermore, a material of the screen 10 having curvature may include textiles or various kinds in which textiles have been subjected to coating treatment, such as mat white, glass beads, ultra beads, a film, fiber glass and diamond. In this case, the reflectance value (or gain) of the screen preferably is 1.8˜2.4. In this case, as the reflectance value increases, it means that an image looks brighter because reflectance of light is high.

Furthermore, referring to FIG. 8, the support refers to a structure, basically including a vertical pole having a framework fixed to the ground and a horizontal pole joined to the frame or the screen 10 having curvature by being joined to the vertical pole. The vertical pole and the horizontal pole are framework materials of the structure disposed to support the screen 10 having curvature and the frame of the screen having curvature, and are preferably made of a solid material. In this case, the support and the frame can preferably fix a connection portion using a connection joint or they are joined together using welding.

Furthermore, in view of the characteristics of the screen 10 having curvature, each horizontal pole is preferably fabricated to have a different length because the distance from the vertical pole to each part of the screen 10 having curvature is different due to curvature of the screen 10 having curvature. The horizontal pole is fabricated to have a varying length through control of a theater server so that the shape of the screen is changed.

In this case, the definition of curvature and a curvature radius used in the present invention is as follows.

When a point P on a curved line moves along the curved line at a constant speed, the direction in which the point moves is changed depending on a moved distance (the length of an arc in the curved line) “s.” In this case, a rate of change is called curvature of the curved line. Assuming that a fine movement distance from one point P on a plane curve to a point Q is “s” and an angle (of an increasing direction of “s”) formed by two tangents at the two points P and Q is Δθ, a direction change rate k is given as follows.

$$k = {lim}_{Δ s \to 0} \vert \frac{Δθ}{Δ s} \vert = \vert \frac{d θ}{ds} \vert \qquad [ Equation 1 ]$$

This is called curvature at the point P of the curved line. Accordingly, curvature of the curved line y=f(x) is:

$$k = \frac{\vert {y}^{″} \vert}{{\{ 1 + {( {y}^{′} )}^{2} \}}^{3 \text{/} 2}} \qquad [ Equation 2 ]$$

The reciprocal of k, R=1/k, is called a curvature radius.

Furthermore, in the screen frame 100 having curvature according to an embodiment of the present invention, the pair of long-axis members 110 includes a first long-axis member 110A and a second long-axis member 110B. The pair of short-axis members 120 includes a first short-axis member 120A and a second short-axis member 120B. The first long-axis member 110A may have one end joined to one end of the first short-axis member 120A and have the other end joined to one end of the second short-axis member 120B. The second long-axis member 110B may have one end joined to the other end of the first short-axis member 120A and have the other end joined to the other end of the second short-axis member 120B. In this case, if “one end” is any one end of a member, “the other end” means the end of the same member on the opposite side. Such a configuration has advantages in that the long-axis members 110 and the short-axis members 120 on the outmost side can support the corners of the screen and form a screen shape having curvature in the vertical axis in addition to the horizontal axis.

Furthermore, the screen 10 having curvature may have a phenomenon in which the screen sags due to the influence of gravity over time in view of its characteristics.

Accordingly, the phenomenon in which the screen sags can be prevented by adding members on the inside of members on the outmost side of the screen in addition to the corners of the screen and joining the added members and the screen together. Furthermore, the sag can be prevented by joining the screen 10 having curvature using various shapes, such as a cross shape or a mesh structure, as the crossing method of the long-axis member 110 and the short-axis member 120. In addition, a point at which the long-axis member 110 intersects the short-axis member 120 is fabricated to form a joining hole in which the crossing portion of a member placed behind and functioning as a support is concaved to a thickness of a member placed ahead and to be supported, thereby facilitating the crossing. Although the long-axis member 110 and the short-axis member 120 are intersected, the screen 10 having curvature can be effectively joined because a surface to which the screen 10 having curvature can be joined is made smooth due to the presence of the joining hole. In this case, according to another embodiment of the present invention, a joining unit for joining a portion where the long-axis member 110 and the short-axis member 120 are intersected may be further included. The long-axis member 110 and the short-axis member 120 may primarily fix a horizontal and vertical connection portion using a frame connection joint, and more solid joining can be formed in a portion to which a lot of load is applied by secondarily performing a welding task. By joining the short-axis member 120 and the long-axis member 110 together as described above, the screen 10 having curvature can be stably supported. Means for fixing the screen to the joining unit is provided and joined to the screen, thereby being capable of preventing the sagging of the screen 10 having curvature.

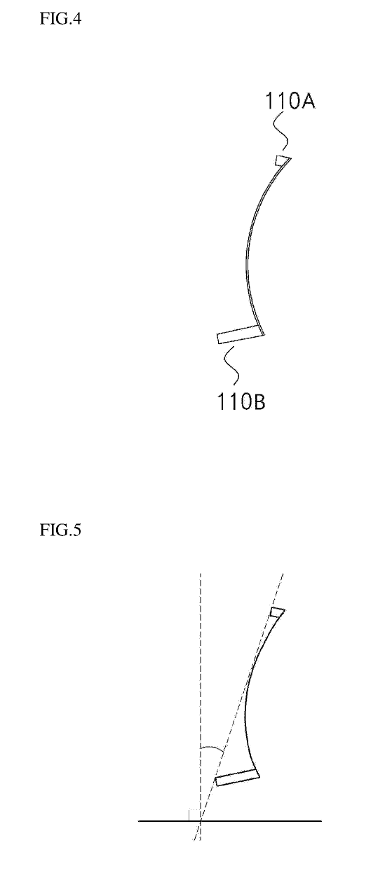

FIG. 4 is a side view seen from the side if the screen frame 100 having curvature according to an embodiment of the present invention has curvature of the ratio of 1:1:0.6˜1.0 and a tilt of 10 to 20 degrees, and FIG. 5 is a reference diagram for illustrating the tilt of the screen frame 100 having curvature according to an embodiment of the present invention.

Referring to FIGS. 4 and 5, assuming that the first long-axis member 110A is placed at the top of the frame and the second long-axis member 110B is placed at the bottom of the frame, the ratio of curvature radii of the first long-axis member 110A, the second long-axis member 110B and the short-axis member 120 may be 1:1:0.6˜1.0. Alternatively, the tilt may be 10 to 20 degrees. In the present invention, the “tilt” means an angle formed by a straight line that connects the first long-axis member 110A and the second long-axis member 110B in the shortest distance and the vertical poles of the support (refer to FIG. 5). The support refers to a structure, basically including a vertical pole having a framework fixed to the ground and a horizontal pole joined to the frame or the screen 10 having curvature by being joined to the vertical pole. The vertical pole is preferably disposed vertically from the ground. The “tilt” also refers to an angle formed by a straight line that connects the first long-axis member 110A and the second long-axis member 110B in the shortest distance and a straight line vertical to the ground.

Meanwhile, the screen 10 having curvature provides a sense of immersion compared to a plane screen, but may generate problems, such as the sagging of the screen depending on curvature of the frame, an unbalanced luminosity distribution of the screen, etc.

Accordingly, if the screen 10 having curvature is installed, a phenomenon in which some area of the screen sags and a phenomenon in which there is a luminosity difference between the center and corner of the screen are generated. The following experiment was performed in order to find out an optimum shape that gives a new sense of immersion while minimizing such a phenomenon.

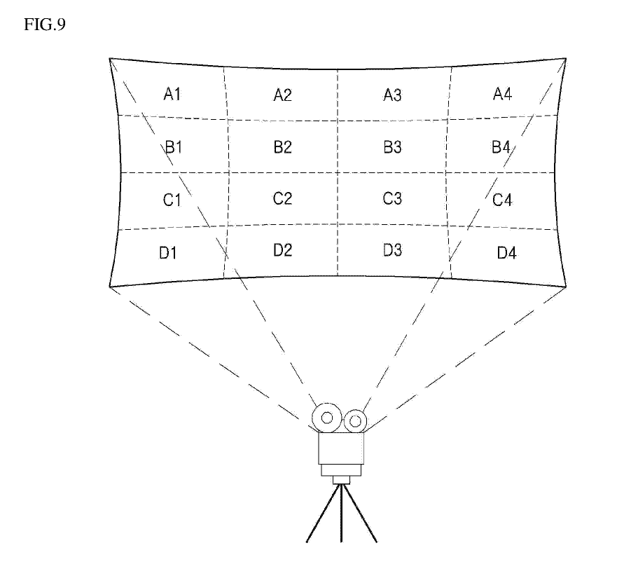

First, a distance measuring device was disposed at a distance of 10000 mm (10 M) from the center of the surface of a wall where the screen was to be installed. The screen was divided into 16 equal parts as shown in FIG. 9. After a lapse of one week, the degree of sagging of the screen was measured by measuring the distance up to each of the 16 areas.

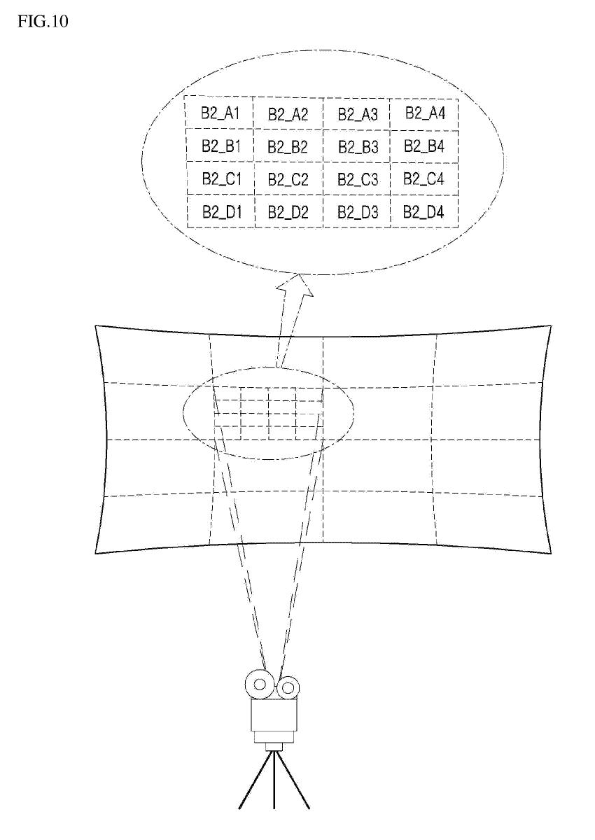

In this case, a difference between an optimum value from the point at which the distance measuring device was disposed to each area of the screen and a value actually measured by the distance measuring device was calculated. If the difference was ±300 mm or more, a sag phenomenon was determined to be generated. If a sag phenomenon was generated in a specific area, the specific area was divided into 16 equal parts again as shown in FIG. 10. A distance up to each of the 16 areas was measured again. An area having a difference of ±300 mm or more was calculated to check a more accurate degree of sag.

In this case, the optimum value was based on a value obtained by measuring the distance after the screen was first installed, and is shown in Table 1. The tilt was 16 degrees, 24 degrees and 30 degrees. The distances checked after one week are shown in Table 2, Table 3 and Table 4. The unit of the measured distance is mm.

TABLE 1

| Optimum distance | | | | |
|---|---|---|---|---|
| (mm in unit) | 1 | 2 | 3 | 4 |
| A | 8530 | 9020 | 9020 | 8530 |
| B | 9040 | 9130 | 9130 | 9040 |
| C | 9490 | 9160 | 9160 | 9490 |
| D | 9950 | 9240 | 9240 | 9950 |

TABLE 2

| Tilt of 16 degrees | | | | | |
|---|---|---|---|---|---|
| (mm in difference) | 1 | 2 | 3 | 4 | |
| A | 230 | 220 | 140 | 80 | Sag of 2% |
| B | 240 | 370 | 240 | 200 | generated |
| C | 50 | 230 | 340 | 490 | |
| D | 20 | 40 | 20 | 30 | |

TABLE 3

| Tilt of 24 degrees | | | | | |
|---|---|---|---|---|---|
| (mm in difference) | 1 | 2 | 3 | 4 | |
| A | 220 | 110 | 140 | 130 | Sag of |
| B | 340 | 450 | 360 | 340 | 17% |
| C | 230 | 140 | 150 | 120 | generated |
| D | 30 | 20 | 50 | 120 | |

TABLE 4

| Tilt of 30 degrees | | | | | |
|---|---|---|---|---|---|
| (mm in difference) | 1 | 2 | 3 | 4 | |
| A | 260 | 210 | 190 | 170 | Sag of |
| B | 410 | 230 | 450 | 310 | 26% |
| C | 260 | 320 | 370 | 220 | generated |
| D | 30 | 20 | 10 | 50 | |

Referring to Table 1 to Table 4, it was found that if the tilt was 24 degrees, a sag phenomenon was partially generated at the upper end of the central portion of the screen and if the tilt was 30 degrees, sagging was generally generated in the central portion of the screen and thus the tilt was not an angle optimized for movie watching.

Accordingly, the degree of sag was the least at the tilt of 16 degrees. As a result of the adjustment of the tilt from 16 degrees, when the tilt was 20 degrees or less, the degree of sag was rarely generated. When the tilt becomes 10 degrees or less, there was a disadvantage in that a three-dimensional effect and a sense of immersion were deteriorated when visual media is played back. Accordingly, it could be checked that when the tilt was 10 to 20 degrees, a sense of immersion was maintained and sag was less generated.

Thereafter, the ratio of the curvature radii of the first long-axis member:the second long-axis member:the short-axis member based on the tilt of 16 degrees having the smallest sag phenomenon was 1:1:1 (Case 1), 1:1:0.8 (Case 2), 1:1:1.2 (Case 3), 1:1.2:1 (Case 4), 1:1.2:0.8 (Case 5), 1:1.2:1.2 (Case 6) and 1:1.2:1.5 (Case 7). In this state, an experiment was performed in the same manner. If, as a result of the experiment, the ratio of the first long-axis member and the second long-axis member is the same (Case 1˜Case 3), it was found that a sag phenomenon was relatively less generated. In the case of Case 2, a sag phenomenon was less generated while the best sense of immersion was maintained.

Meanwhile, in order to check the ratio of the curvature radius of the frame in which a luminosity difference between the center and corner of the screen was the least, an experiment in which the ratio of the curvature radius of the frame was changed, the screen was divided into 16 equal parts, and brightness (i.e., an amount obtained by dividing luminous intensity of a light source having a specific range by the area of the light source) of the screen was performed in the state in which the tilt was set to 10 to 20 degrees.

First, a test image (black image) from a projector was projected on the screen, a luminosity measuring device was disposed at a distance of 10 M from the center of the surface of a wall, and luminosity in each area was measured.

In general, screen luminosity was measured to be bright at the central portion and was measured to be darker toward the end. A luminosity difference between the center point and an end point is less, and an image is sharp and a sense of difference is reduced as the number of bright points is increased. An equation for giving a higher score to a more uniform luminosity distribution was created, and the scores were evaluated based on the equation.

Accordingly, a score evaluated in the frame of each curvature radius is as follows:

An evaluation score=10 scores−(a standard deviation of a brightness areas divided into 16 equal parts).

Several types of frame curvature was generated, and the results of the measurement of scores according to a luminosity distribution are shown in Table 5. In this case, the unit of measured brightness was fL.

TABLE 5

| Brightness | | | | | | | | | | | | | | |
|---|---|---|---|---|---|---|---|---|---|---|---|---|---|---|
| distribution | First long-axis | | | | | First long-axis | | | | | First long-axis | | | |
| (Brightness | member: second | | | | | member: second | | | | | member: second | | | |
| fL) | long-axis member | | | | | long-axis member | | | | | long-axis member | | | |
| Short-axis | 8,000: 8,000 | | | | Short- | 10,000: 8,000 | | | | Short- | 8,000: 8,000 | | | |
| member | 10.1 | 11.4 | 12.3 | 11.5 | axis | 6.6 | 11.4 | 12.3 | 5.6 | axis | 1.6 | 3.5 | 4.3 | 1 |
| curvature | 10.7 | 14.6 | 12.7 | 9 | member | 8.5 | 13.5 | 11.2 | 7.6 | member | 2.5 | 16 | 14 | 0.2 |
| 8,000 | 9.3 | 12.7 | 13 | 12 | curvature | 9.3 | 12.7 | 13 | 12 | curvature | 1 | 8.3 | 6.8 | 2.1 |
| | 11 | 11.4 | 11.5 | 11 | 10,000 | 7.7 | 9.9 | 11.5 | 8.8 | 15,000 | 3.2 | 5 | 2.4 | 1.5 |
| | 8.6 score | | | | | 7.5 score | | | | | 5.4 score | | | |
| | 10,000: 10,000 | | | | | 8,000: 10,000 | | | | | 10,000: 10,000 | | | |
| | 10.1 | 11.5 | 12.4 | 11.9 | | 3 | 6.7 | 8.8 | 3.4 | | | | | |
| | 10.4 | 12.6 | 12.7 | 11.2 | | 4.1 | 13.7 | 12.4 | 7.4 | | | | | |
| | 11.4 | 12.7 | 12.8 | 12 | | 2.6 | 8.6 | 7.8 | 4.1 | | | | | |
| | 11.5 | 11.2 | 12.1 | 11.1 | | 5.1 | 3 | 3.1 | 4 | | | | | |
| | 9.2 score | | | | | 6.6 score | | | | | 5.3 score | | | |
| | 15,000: 15,000 | | | | | 15,000: 15,000 | | | | | 15,000: 15,000 | | | |
| | 10.2 | 11.4 | 12.4 | 11.2 | | 9.7 | 10.2 | 10 | 9.8 | | 8.6 | 11.4 | 12.3 | 7.9 |
| | 11.3 | 12.5 | 11.2 | 10.3 | | 10.4 | 11.2 | 12.1 | 11.2 | | 9.2 | 13.5 | 11.2 | 8.9 |
| | 11.6 | 12.7 | 12.4 | 11.4 | | 10.2 | 11.4 | 10.2 | 10.9 | | 9.3 | 12.7 | 13 | 10 |
| | 10.4 | 9.9 | 11.5 | 10.4 | | 8.9 | 9.7 | 9.8 | 10 | | 9.3 | 9.9 | 11.5 | 8.8 |

| | | |
|---|---|---|
| 9.1 score | 9.2 score | 8.2 score |

Furthermore, the results of a luminosity distribution of the screen visually expressed based on the scores of the experiment may be understood to be the same degree as luminosity distributions of Table 6.

Referring to Table 5, the ratio of the curvature radii of the first long-axis member:the second long-axis member:the short-axis member having 8 scores or more was 8000:8000:8000 (8.6 score), 10000:10000:8000 (9.2 score), 15,000:15,000:8000 (9.1 score), 15,000:15,000:10,000 (9.2 score), and 15,000:15,000:15,000 (8.2 score). It may be seen that a luminosity distribution is the most uniform in a range of 1:1:0.6˜1.0 if the ratio is reduced to its lowest terms.

Accordingly, if the screen having curvature is installed, the results of the experiment revealed that when the tilt is set to 10 to 20 degrees and the ratio of curvature is set to 1:1:0.6˜1.0, a phenomenon in which the screen sags and a phenomenon in which a luminosity difference is generated between the center and corer of the screen can be solved.

Accordingly, as a result of the adjustment of a tilt and curvature after several ratios were set as in the experiment, if the ratio is 1:1:0.6˜1.0 and the tilt is 10 to degrees, there are advantages in that sag is rarely generated, screen luminosity is uniformly distributed and a maximum sense of immersion can be provided to an audience. More specifically, if visual media is projected on the screen having curvature in which the ratio of the curvature radius is 1:1:0.8 and the tilt is 16 degrees as in the ratio of 10000:10000:8000 (9.2 score), it can be seen that a 2-D movie has the same effect as a 3-D movie and a 3-D movie has an effect of the feeling of movement much higher than that of a plane screen because the distance from a projector from which an image is projected to the screen is different due to the characteristics of the screen having curvature.

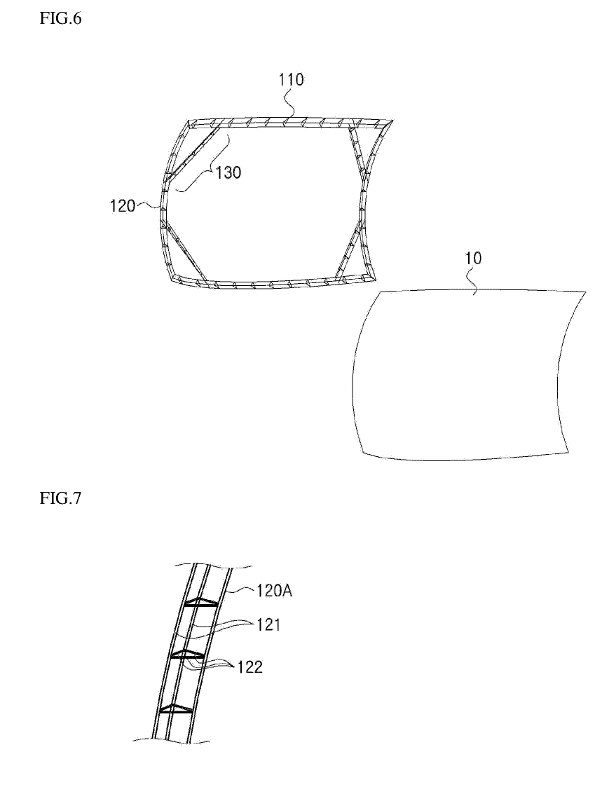

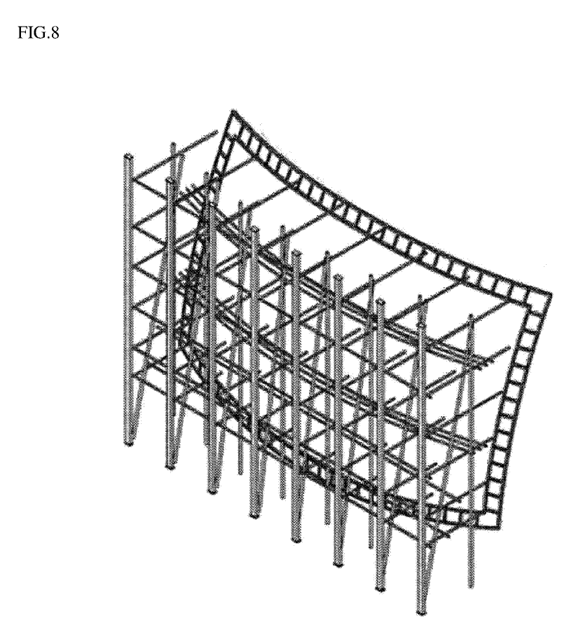

FIG. 6 is a diagram showing the structure of the screen frame 100 having curvature to which diagonal members 130 have joined in accordance with an embodiment of the present invention.

Referring to FIG. 6, the screen frame 100 having curvature according to an embodiment of the present invention may further include diagonal member 130, each having one end and the other end respectively joined to points of the long-axis member 110 and the short-axis member 120 joined together. If the screen is hung on the long-axis member 110 or the short-axis member 120 for a long time, there is a problem in that curvature may be changed because the member is bent. A phenomenon in which the member is bent can be prevented because the diagonal member 130 joined to the long-axis member 110 and the short-axis member 120 supports the long-axis member 110 and the short-axis member 120.

Furthermore, according to another embodiment of the present invention, the long-axis member 110 and the short-axis member 120 may include different points having two or more pieces of curvature within a single member. Accordingly, since the members having different curvature are used within a single member, the shape of the screen 10 having curvature can be implemented to be suitable for the shape of a theater having a dome shape and various visual effects can be provided to an audience.

For example, the short-axis member 120 may be fabricated to have a shape in which curvature increases from the upper end to the lower end, a shape in which curvature decreases from the upper end to the lower end or a shape in which curvature at a previously designated point is the greatest and curvature decreases toward the upper end and the lower end. If the short-axis member 120 is installed on a theater having a dome-shaped structure, there are advantages in that the shape of the screen can be made identical with the dome shape and a speaker can be installed on the back of screen 10 having curvature depending on a dome shape and can transfer a uniform sound to several seats.

Furthermore, according to another embodiment of the present invention, the long-axis member 110 and the short-axis member 120 has different curvature.

For example, the short-axis member 120 may have a shape in which the short-axis member 120 disposed at the central part has the greatest curvature and the curvature becomes smaller toward the short-axis member 120 disposed at the corner or a shape in which the long-axis member 110 disposed at the central part has the greatest curvature and the curvature becomes smaller toward the long-axis member 110 disposed at the corner.

In such a case, a more sense of immersion can be provided to an audience compared to a conventional method using a plane screen because the central part of the screen 10 having curvature is more concaved than the corner.

Furthermore, the short-axis member 120 may have a shape in which the short-axis member 120 disposed at the central part has the smallest curvature and the curvature becomes greater toward the short-axis member 120 disposed at the corner or a shape in which the long-axis member 110 disposed at the central part has the smaller curvature and the curvature becomes greater toward the long-axis member 110 disposed at the corner.

In such a case, a greater sense of immersion can be provided to an audience compared to a conventional plane screen because the central part of the screen 10 having curvature has a convex shape and thus a three-dimensional effect is formed on the screen itself.

As described above, according to the present invention, several types of screens can be provided using members having various types of curvature. Furthermore, curvature of the screen 10 having curvature can be changed even after installation by changing curvature of the frame using the support.

FIG. 7 is a diagram showing the structure of the short-axis member 120 of the elements of the screen frame 100 having curvature according to an embodiment of the present invention.

Referring to FIG. 7, the screen frame 100 having curvature according to an embodiment of the present invention may further include the post unit 111, 121 formed in one direction with curvature of a specific size and spaced apart from the long-axis member 110 or the short-axis member 120 at a specific interval and the beam 112, 122 joined between the post unit 111 and the long-axis member 110 or the post unit 121 and the short-axis member 120.

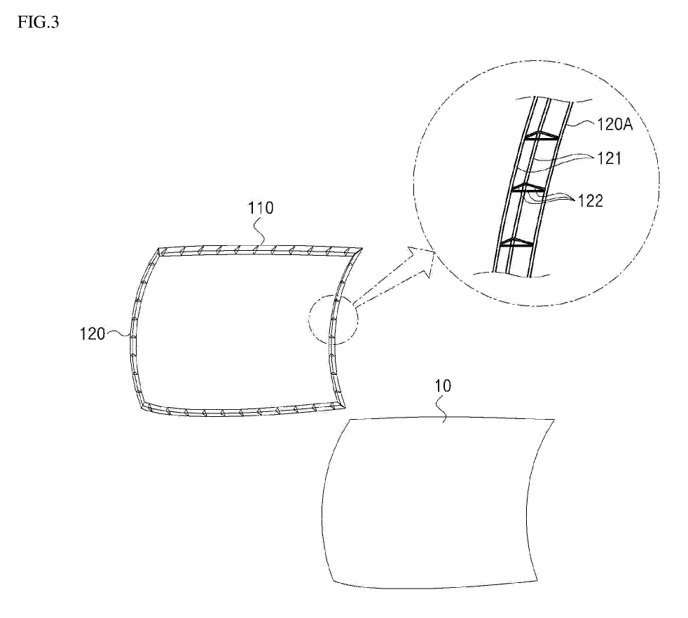

In this case, the number of post units 111, 121 may be 1 (refer to FIG. 2) or 2 (refer to FIG. 3) or more and may be fabricated in various manners depending the size of a theater or curvature of the frame.

More specifically, the screen is fabricated larger than the frame. It is preferred that a shape of the screen 10 having curvature is formed in such a way as to bind the post units 111 and 121 or the beams 112 and 122 spaced apart from the long-axis members 110 and short-axis members 120 of the frame at a specific interval and the screen using a string. Accordingly, the long-axis member 110 and the short-axis member 120 is fabricated to be disposed along with the plurality of post units 111 and 121 so that one post unit is joined to the support and the other post unit is joined to the perforation of the screen using a string to form curvature of the screen while being joined to the screen.

Meanwhile, according to another embodiment of the present invention, the screen frame includes the first long-axis member 110A and the second long-axis member 110B formed in the first direction and spaced apart from each other at a specific interval and the first short-axis member 120A and the second short-axis member 120B formed in the second direction and spaced apart from each other at a specific interval. In this case, an angle formed by the straight line that connected the first long-axis member 110A and the second long-axis member 110B at the shortest distance and the vertical poles of the support may be 10 to 20 degrees. Accordingly, a screen having only a tilt without curvature can be fabricated. In this case, the short-axis member 120 supports the vertical axis of the screen and has curvature of a specific size, thereby being capable of fabricating the screen 10 having curvature only in the vertical axis.

Furthermore, a theater equipped with the screen frame having curvature according to the present invention may include the frame having all of the characteristics of the screen frame having curvature, and a redundant description related to the frame is omitted.

According to an embodiment of the present invention, a method for fabricating the screen frame 100 having curvature may include the steps of (a) fabricating the pair of long-axis members 110 formed in the first direction with curvature of a specific size and the pair of short-axis members 120 formed in the second direction with curvature of a specific size; (b) placing the pair of short-axis members 120 in such a way as to be spaced apart from each other at a specific interval; (c) joining the pair of short-axis members 120 and the pair of long-axis members 110 to form the four corners.

Furthermore, the pair of long-axis members 110 includes the first long-axis member 110A and the second long-axis member 110B, and the pair of short-axis members 120 includes the first short-axis member 120A and the second short-axis member 120B. At the step (c), the first long-axis member 110A may have one end joined to one end of the first short-axis member 120A and have the other end joined to one end of the second short-axis member 120B. Furthermore, the second long-axis member 110B may have one end joined to the other end of the first short-axis member 120A and have the other end joined to the other end of the second short-axis member 120B.

Furthermore, according to another embodiment of the present invention, at the step (a), the first long-axis member 110A, the second long-axis member 110B, the first short-axis member 120A and the second short-axis member 120B may be fabricated to have a ratio of curvature radii of 1:1:0.6˜1.0.

Furthermore, the method may further include the step of (d) joining one end and the other end of the diagonal member 130 formed in a diagonal direction at respective points of the long-axis member 110 and the short-axis member 120 joined together after the step (c). If the screen is hung on the long-axis member 110 or the short-axis member 120 for a long time, there is a problem in that curvature may be changed because the member is bent. A phenomenon in which the members are bent can be prevented because the diagonal member 130 joined to the long-axis member 110 and the short-axis member 120 supports the long-axis member 110 and the short-axis member 120.

Meanwhile, at the step (a), the long-axis member 110 and the short-axis member 120 may be fabricated to have different points having two or more pieces of curvature within a single member. Accordingly, since the members having different curvature are used within a single member, the shape of the screen 10 having curvature can be implemented to be suitable for the shape of a theater having a dome shape and various visual effects can be provided to an audience.

Furthermore, the step (a) may include the steps of i) placing the post units 111, 121 formed in one direction with curvature of a specific size in such a way as to be spaced apart from the long-axis member or the short-axis member at a specific interval; and ii) joining the beams 112, 122 between the post units 111 and the long-axis member 110 or the post units 121 and the short-axis member 120.

In this case, the number of post units 111, 121 may be 1 (refer to FIG. 2) or 2 (refer to FIG. 3) and may be various depending on the size of a theater or curvature of the frame.

More specifically, the screen is fabricated larger than the frame. It is preferred that a shape of the screen 10 having curvature is formed in such a way as to bind the post units 111 and 121 or the beams 112 and 122 spaced apart from the long-axis members 110 and short-axis members 120 of the frame at a specific interval and the screen using a string. Accordingly, the long-axis member 110 and the short-axis member 120 is fabricated to be disposed along with the plurality of post units 111 and 121 so that one post unit is joined to the support and the other post unit is joined to the perforation of the screen using a string to form curvature of the screen while being joined to the screen.

According to an embodiment of the present invention, a method for installing the screen frame 100 having curvature, including the first long-axis member 110A and the second long-axis member 110B formed in the first direction with curvature of a specific size and the first short-axis member 120A and the second short-axis member 120B formed in the second direction with curvature of a specific size may include the steps of (a) disposing the plurality of vertical poles in the vertical direction to the ground; (b) joining the plurality of horizontal poles to the vertical poles in the horizontal direction to the ground; (c) installing the horizontal poles so that the first and the second long-axis members 110B and the first and the second short-axis members 120B have the four corners.

The vertical pole is a framework material disposed in the vertical direction to the ground, and the horizontal pole is a framework material having one end joined to the vertical pole in the horizontal direction to the ground. The other ends of the horizontal poles disposed in the same horizontal axis and connected together form a curved shape having curvature of a specific size and are joined to the screen frame 100 having curvature. Such a framework structure of the horizontal pole and the vertical pole is called the support.

The support is a framework material of a structure basically installed to support the screen 10 having curvature and the frame of the screen 10 having curvature, and is preferably made of a solid material. Furthermore, in view of the characteristics of the screen 10 having curvature, each horizontal pole is preferably fabricated to have a different length because the distance from the vertical pole to each part of the screen 10 having curvature is different due to curvature of the screen 10 having curvature. The horizontal pole is fabricated to have a varying length through control of a theater server so that the shape of the screen is changed.

In this case, at the step (a), the vertical poles are closely attached to the surface of a wall of a theater. Accordingly, the vertical poles are joined to the surface of a wall of a theater in addition to the ground, thereby being capable of supporting the frame more stably.

Furthermore, at the step (c), the first long-axis member 110A, the second long-axis member 110B, the first short-axis member 120A and the second short-axis member 120B may be installed on the horizontal poles to form a ratio of curvature radii of 1:1:0.6˜1.0. Furthermore, an angle formed by the straight line connecting the first long-axis member 110A and the second long-axis member 110B at the shortest distance and the vertical poles may have 10 to 20 degrees. As a result of the adjustment of a tilt and curvature after several ratios were set as in the experiment, if the ratio is 1:1:0.6˜1.0 and the tilt is 10 to 20 degrees, there are advantages in that sag is rarely generated, screen luminosity is uniformly distributed and a maximum sense of immersion can be provided to an audience.

Furthermore, the method may further include (d) joining one end and the other end of the diagonal member 130 formed in a diagonal direction at respective points of the long-axis member 110 and the short-axis member 120 joined together, after the step (c). If the screen is hung on the long-axis member 110 or the short-axis member 120 for a long time, there is a problem in that curvature may be changed because the member is bent. A phenomenon in which the member is bent can be prevented because the diagonal member 130 joined to the long-axis member 110 and the short-axis member 120 supports the long-axis member 110 and the short-axis member 120.

As described above, those skilled in the art to which the present invention pertains will understand that the present invention may be implemented in other detailed forms without changing the technological spirit or essential characteristics of the present invention. Accordingly, the aforementioned embodiments should not be construed as being limitative, but should be construed as being only illustrative from all aspects. The range of right of the present invention is disclosed in the appended claims rather than the detailed description, and it should be understood that all modifications or variations derived from the meanings and scope of the present invention and equivalents thereof are included in the scope of the appended claims.

### INDUSTRIAL APPLICABILITY

The present invention relates to the screen frame having curvature. The screen frame having curvature includes the pair of long-axis members formed in the first direction and spaced apart from each other at a specific interval and the pair of short-axis members formed in the second direction and spaced apart from each other at a specific interval. The long-axis members and the short-axis members have curvature of a specific size, and the pair of long-axis members and the pair of short-axis members are joined together to have four corners. Accordingly, an audience can have various effects because horizontal and horizontal curvature is formed in a screen using a member having curvature in the vertical axis in addition to the horizontal axis.

1. A screen frame having curvature, comprising:
a pair of long-axis members formed in a first direction and spaced apart from each other at a specific interval; and
a pair of short-axis members formed in a second direction and spaced apart from each other at a specific interval,
wherein the long-axis member and the short-axis member have curvature of a specific size, and the pair of long-axis members and the pair of short-axis members are joined together to have four corners.

2. The screen frame of claim 1, wherein:
the pair of long-axis members comprises a first long-axis member and a second long-axis member,
the pair of short-axis member comprises a first short-axis member and a second short-axis member,
the first long-axis member has one end joined to one end of the first short-axis member and has the other end joined to one end of the second short-axis member, and
the second long-axis member has one end joined to the other end of the first short-axis member and has the other end joined to the other end of the second short-axis member.

3. The screen frame of claim 2, wherein a ratio of curvature radii of the first long-axis member, the second long-axis member and the short-axis member is 1:1:0.6˜1.0.

4. The screen frame of claim 2, wherein an angle formed by a straight line connecting the first long-axis member and the second long-axis member at a shortest distance and a vertical pole of a support is 10 to 20 degrees.

5. The screen frame of claim 1, further comprising a diagonal member having one end and the other end respectively joined to points of the long-axis member and the short-axis member joined together.

6. The screen frame of claim 1, wherein the long-axis member and the short-axis member have different points having two or more pieces of curvature within a single member.

7. The screen frame of claim 1, further comprising:
post units formed in one direction with curvature of a specific size and spaced apart from the long-axis member or the short-axis member at a specific interval; and
beams joined between the post units and the long-axis member or the post units and the short-axis member.

8. A screen frame having curvature, comprising:
a first long-axis member and a second long-axis member formed in a first direction and spaced apart from each other at a specific interval; and
a first short-axis member and a second short-axis member formed in a second direction and spaced apart from each other at a specific interval,
wherein an angle formed by a straight line connecting the first long-axis member and the second long-axis member at a shortest distance and a vertical pole of a support is 10 to 20 degrees.

9. The screen frame of claim 8, wherein the short-axis member supports a vertical axis of a screen and has curvature of a specific size.

10. The screen frame of claim 9, wherein a ratio of curvature radii of the first long-axis member, the second long-axis member and the short-axis member is 1:1:0.6˜1.0.

11. The screen frame of claim 8, further comprising a diagonal member having one end and the other end respectively joined to points of the long-axis member and the short-axis member joined together.

12. The screen frame of claim 8, wherein the first and the second long-axis members and the first and the second short-axis members have different points having two or more pieces of curvature within a single member.

13. The screen frame of claim 8, further comprising:
post units formed in one direction with curvature of a specific size and spaced apart from the first and the second long-axis members or the first and the second short-axis members at a specific interval; and
beams joined between the post units and the first long-axis member or the post units and the first short-axis member or the post units and the second long-axis member or the post units and the second short-axis member.

14. A method for installing a screen frame having curvature, the screen frame comprising a first long-axis member and a second long-axis member formed in a first direction with curvature of a specific size and a first short-axis member and a second short-axis member formed in a second direction with curvature of a specific size, the method comprising steps of:
(a) disposing a plurality of vertical poles in a vertical direction to a ground;
(b) joining a plurality of horizontal poles to the vertical poles in a horizontal direction to the ground; and
(c) installing the horizontal poles so that the first and the second long-axis members and the first and the second short-axis members have four corners.

15. The method of claim 14, wherein at the step (a), the vertical poles are closely attached to a surface of a wall of a theater.

16. The method of claim 14, wherein at the step (c), the first long-axis member, the second long-axis member the first short-axis member and the second short-axis member are installed on the horizontal poles to form a ratio of curvature radii of 1:1:0.6˜1.0.

17. the method of claim 14, wherein at the stop (c), an angle formed by a straight line connecting the first long-axis member and the second long-axis member at a shortest distance and the vertical poles is 10 to 20 degrees.

18.-27. (canceled)
